(19) United States
(12) Patent Application Publication
(10) Pub. No.: US 2009/0185886 A1
(43) Pub. Date: Jul. 23, 2009

(54) SELF-LEVELLING MECHANICAL SYSTEM FOR A MATERIAL HANDLING DEVICE

(76) Inventors: RusselL Janzen, Rosedale (CA); Scott McGhee, Rosedale (CA); Dean Scodellaro, Rosedale (CA); Don Poole, Rosedale (CA)

Correspondence Address: WINSTEAD PC, P.O. BOX 50784, DALLAS, TX, 75201, US

(21) Appl. No.: 12/112,305

(22) Filed: Apr. 30, 2008

Related U.S. Application Data
(60) Provisional application No. 61/022,423, filed on Jan. 21, 2008.

(51) Int. Cl. B65G 67/02

(52) U.S. Cl. 414/585

(57) ABSTRACT

The present invention provides a material handling device comprising: a support trailer configured for movement thereof; a material holding device pivotally connected to the support trailer, the material holding device configured for reversible rotational movement between a first lowered orientation and a second elevated orientation; an accessory support pivotally connected to the material holding device, wherein the accessory support is coupled to the material holding device at a location wherein the accessory support translates when the material holding device is reversably moved between the first lowered orientation and the second elevated orientation; and a linkage system operatively interconnecting the support trailer, the material holding device and the accessory support, wherein the linkage system is configured to substantially maintain a desired orientation of the accessory support during reversible rotational movement of the material holding device.

### CROSS REFERENCE TO RELATED APPLICATIONS

The present application claims priority to U.S. Provisional Patent Application No. 61/022,423, filed Jan. 21, 2008, the contents of which are incorporated herein by reference.

### FIELD OF THE INVENTION

The present invention pertains to leveling systems and more particularly to a self leveling mechanical system for a material handling device.

### BACKGROUND

As would be known, there are a plurality of material handling devices available. A number of industries require varying formats of material handling devices, wherein some of these industries can include, farming, landscaping and construction. Material handling devices typically carry a material from a first location to a second location, wherein at the second location the material is subsequently unloaded, using for example an accessory which is attached to the material handling device, wherein the accessory can be for example a spreader, spinner, conveyor, auger or other mechanism as would be readily understood.

Having particular regard to landscaping industry, a material handling device can be a topdresser. There are a plurality of topdressers that exist today which utilize multi-function trailers that can be pulled by a tractor for topdressing. Trailer and tractor can be used in combination in a tender-like fashion. Known trailers typically comprise a box or a bin for holding particulate matter that may be sloped towards its lower portion. Particulate matter may be disposed by gravitational or agitation-assisted discharge through an opening proximate the bottom of the bin. The particulate matter may be disposed onto or through a conveyor or auger based chute or hopper in order to facilitate targeted disposition of the particulate matter to an area accessible by the chute or hopper. Conveyors or augers may also be used to elevate the particulate matter for disposal. Spreaders or spinners, either alone or in combination with conveyor or auger-based systems may be used. Spreaders or spinners are useful if disposition of the particulate matter to areas beyond those accessible with chute or hopper based systems is desired but only provide limited targeted disposition. Many existing chute or hopper-based systems facilitate disposition of particulate matter from one side of or from below the trailer but require extended hopper lengths in order to enable disposition of matter across nearby obstacles such as a fence or bush, for example. Systems embodying one or more of these features are described in U.S. Pat. Nos. 5,538,388, 5,108,249, 5,100,281, 4,493,601, 4,218,169, 3,402,805 and 1,364,581, for example.

Many material handling devices are configured in order to adjust the orientation of an attached box or bin associated therewith, wherein this adjustment of the orientation of the box or bin can aid in the unloading of the material therefrom. For example, having regard to a trailer configured with a dump box, this adjustment of orientation may result in the elevation of a forward section of the box which rotates about the rear of the trailer. In this configuration if an accessory is connected to the rear of the trailer, the adjustment of the orientation of the of the dump box typically does not change the associated orientation of the accessory with respect to the ground. However, if the accessory is connected to the dump box at another location, wherein during the adjustment of the orientation of the dump box, the relative ground position of the accessory is changed, the orientation of the accessory can be changed. Depending on the type of accessory, this change in the relative orientation of the accessory with the dump box may reduce the effectiveness or ease of operability of the accessory.

Therefore there is a need to improve particulate matter discharge systems to overcome at least one of the deficiencies of known systems for material handling devices.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a self-leveling mechanical system for a material handling device. In accordance with an aspect of the present invention there is provided a material handling device comprising: a support trailer configured for movement thereof; a material holding device pivotally connected to the support trailer, the material holding device configured for reversible rotational movement between a first lowered orientation and a second elevated orientation; an accessory support pivotally connected to the material holding device, wherein the accessory support is coupled to the material holding device at a location wherein the accessory support translates when the material holding device is reversably moved between the first lowered orientation and the second elevated orientation; and a linkage system operatively interconnecting the support trailer, the material holding device and the accessory support, wherein the linkage system is configured to substantially maintain a desired orientation of the accessory support during reversible rotational movement of the material holding device.

### BRIEF DESCRIPTION OF THE FIGURES

FIG. 1 illustrates a material handling device according to one embodiment of the present invention, wherein the material handling device is in a lowered orientation.

FIG. 2 illustrates a material handling device according to one embodiment of the present invention, wherein the material handling device is in an elevated orientation.

FIG. 3 schematically illustrates a linkage system according to one embodiment of the present invention, wherein the linkage system is illustrated in three different angular configurations.

FIG. 4 schematically illustrates one of the angular configurations of the linkage system illustrated in FIG. 3.

FIG. 5A illustrates a material handling device according to one embodiment of the present invention, wherein the material handling device is in a lowered orientation.

FIG. 5B schematically illustrates the orientations of the linkage system as illustrated in FIG. 5A.

FIG. 6A illustrates a material handling device according to one embodiment of the present invention, wherein the material handling device is in an elevated orientation.

FIG. 6B schematically illustrates the orientations of the linkage system as illustrated in FIG. 6A.

FIG. 7 illustrates a close up of the material handling device illustrated in FIG. 5A.

### DETAILED DESCRIPTION OF THE INVENTION

### Definitions

The term “particulate matter” is used to define types of fluid or granular particle based material that is capable of free flowing under its own weight in clumped, baked together, sunken or at least loosened or liquefied bulk configurations or other configurations as would be readily understood by a worker skilled in the art. Particular matter may comprise particles such as chips or pellets, powder, grit, pebbles, gravel, rubble, ballast, crushed or broken solids or the like. For example, particulate matter can be an organic or inorganic materials including grain, wood, fertilizer, seed, soil, peat, sand, rock or stone, for example. Particulate matter may include all dry, moist or wet forms of the above examples as well as liquid matter such as sludge, for example. The liquid may be aqueous or otherwise.

As used herein, the term “about” refers to a ±10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a material handling device comprising: a support trailer configured for movement thereof and a material holding device pivotally connected to the support trailer. The material holding device is configured for reversible rotational movement between a first lowered orientation and a second elevated orientation. An accessory support is pivotally connected to the material holding device at a position, wherein when the material holding device is reversably moved between the first lowered orientation and the second elevated orientation, the accessory support is translated. The material handling device further comprises a linkage system operatively interconnecting the support trailer, the material holding device and the accessory support. The linkage system is configured to substantially maintain a desired orientation of the accessory support during reversible rotational movement of the material holding device.

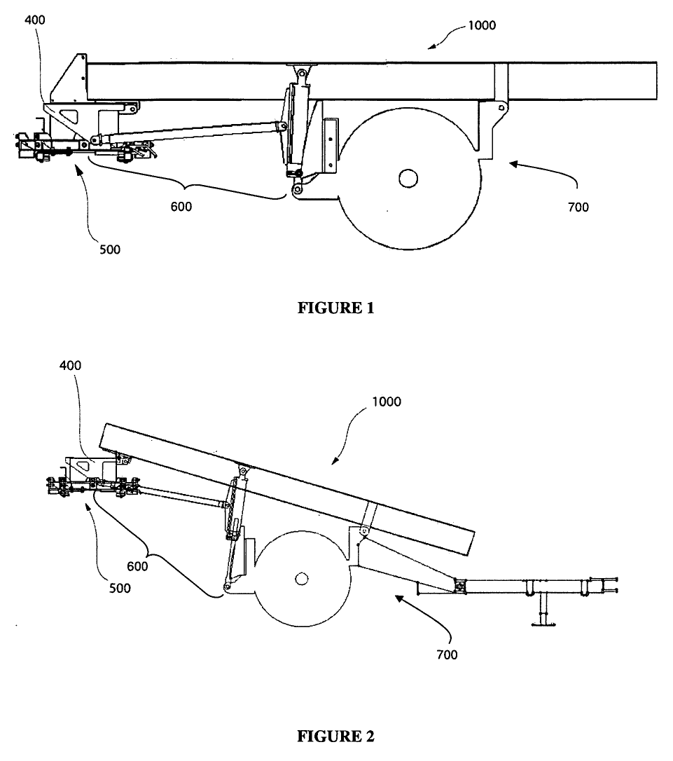

FIG. 1 illustrates an embodiment of the present invention, wherein the overall configuration of the material handling device is in the lowered orientation. In addition, FIG. 2 illustrates an embodiment of the present invention, wherein the overall configuration of the material handling device is in an elevated configuration. The material handling device comprises a support trailer 700 and a material holding device 1000, of which only a portion is illustrated. Pivotally coupled to the material holding device 1000 is an accessory support 400, which is configured to support an accessory 500, wherein the accessory support and the accessory can be configured as a single component or may be configured as two separate components which are interconnectable. The material handling device further comprises a linkage system which operatively interconnects the support trailer, the material holding device and the accessory support. The linkage system is configured in order to substantially maintain a desired orientation of the accessory support in both the lowered and elevated orientations, together with orientations therebetween. As illustrated in FIGS. 1 and 2, the accessory support and the accessory substantially maintain an orientation which is substantially level with horizontal in both the elevated and lowered orientations.

For example, a material handling device configured in this manner may be useful when disposing particulate matter over nearby elevated obstacles in tight spaces where manoeuvring is limited or difficult. It can also be useful, when a conveyor-based accessory needs to be raised and kept reasonably horizontal to the ground during operating conditions. This material handling device can further be useful in cases where the conveyer based accessory can be swivelled to one side or both sides of the trailer in order to be able to dispose particulate matter to within a certain range to the left and/or right and behind the trailer by pivoting the conveyor in an arch about a reasonably vertical axis, for example.

### Material Handling Device

The material handling device comprises a support trailer which is configured to provide support to the components of the material handling device, in addition to provide a means for movement of the material handling device. For example, movement of the material handling can be enabled by a wheel system, track system or other movement system as would be readily understood by a worker skilled in the art.

The material handling device further comprises a material holding device which is configured to hold the particulate matter which the material handling device is transporting or depositing. The material holding device comprises a box, hopper or bin or the like which can hold the matter. In one embodiment, the material holding device can be configured as a two part system comprising a shell defining a volume and a support frame which can provide the structural rigidity to the material holding device. In another embodiment, the material holding device is configured as an integrated device wherein the shell is configured with integrated structural integrity. Interconnecting the support trailer and the material holding device is one or more actuators which are configured to pivot the material holding device relative to the support trailer. The one or more actuators can be rams configured to function hydraulically, pneumatically or other means as would be readily understood.

The material holding device can include a conveyor system (not illustrated) located for example proximate to the bottom of the material holding device, such that the conveyor system can provide a means for the movement of the particulate matter within the material holding device. The material holding device may have a gate or other exit associated therewith which is proximate to the bottom of the rear end of the trailer so that particulate matter held in it can be disposed, for example assisted by the conveyor, through the gate or exit. The material holding device is pivotable relative to the support trailer of the material handling device, wherein this pivotal attachment can aid in the disposition of the particular matter.

Pivotally connected to the material handling device is an accessory support and/or accessory which can provide additional distribution of the particulate matter being disposed from the material holding device. For example, the particulate matter processed by the accessory can be desirably disposed under operating conditions. The accessory or accessory support is operatively coupled to the material holding device at a location, wherein when the material holding device is moved between a first lowered orientation and a second elevated orientation, or therebetween, the accessory and/or accessory support is translated, for example elevated or lowered relative to a previous position.

### Linkage System

The linkage system operatively interconnects the support trailer, the material holding device and the accessory support. The linkage system is configured such that it is capable of substantially maintaining a desired orientation of the accessory support during reversible rotational movement of the material holding device. For example, the linkage system can maintain the accessory support substantially parallel to the ground, irrespective of the relative position of the material holding device.

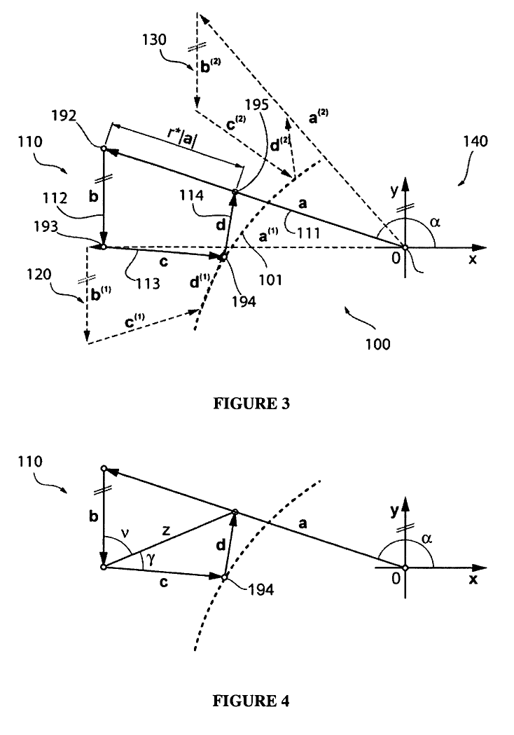

A schematic illustration of a linkage system according to one embodiment of the present invention is shown in FIGS. 3 and 4. FIG. 3 illustrates three configurations 110, 120 and 130 of a four bar linkage system differing in the angle α of the first link relative to the reference frame defined by the x-y coordinate system. FIG. 4 illustrates configuration 110 only. The four links of the four bar linkage, also denoted by vectors a, b, c and d, and by reference numerals 111, 112, 113 and 114, respectively, are interconnected via pivot joints 192, 193, 194 and 195, as well as to a reference frame via pivot joint 191. The reference frame (not illustrated) defines coordinate system 140.

The first link 111 is a substantially rigid link along its full length and is pivotable about pivot joint 191 relative to the reference frame. It is noted that the first link is substantially rigid, although the line connecting the axes of the first pivot joint and second pivot joint may include an angle other than γ with the line connecting the axes of the second and the fifth pivot joint. The first link does not hinge in the fifth pivot joint 195. The second link 112 is pivotable about pivot joint 192 relative to the first link 111. The third link 113 is pivotable about pivot joint 193 relative to the second link 112. The fourth link 114 is pivotable about pivot joint 194 relative to the third link 113. In addition to being pivotable about pivot joint 194, the fourth link 114 is also pivotable about pivot joint 195 relative to the first link 111. The pivot joint 195 is located at a distance about r*|a| from the pivot joint 192, wherein r defines the fraction of the length |a| of vector a.

In one embodiment of the present invention, the linkage system is configured so that the second link 112 remains oriented in a predetermined direction when the fourth link 114 is angled properly in a predetermined fashion in correspondence with the angle α of the first link 111. This can be accomplished for at least a portion of the full range [0,2π] of the angle α, by moving pivot joint 194 along curve 101. The specific portion and the shape of the curve 101 can be determined by firstly whatever predetermined orientation the second link 112 is desired to maintain when the angle α changes, secondly by the lengths of each link, and thirdly the overall configuration of the linkage system. For the embodiment schematically illustrated in FIGS. 3 and 4, the predetermined orientation of the second link 112 is parallel to the y-axis of the coordinate system 140. The movement of pivot joint 194 along curve 101 is exemplified in three different configurations 110, 120 and 130 of the four bar linkage for different orientations of the first link 111 as illustrated in FIG. 3. As illustrated the orientation of the second link remains the same if pivot joint 194 is positioned at respective points on curve 101. For example, the predetermined direction of the second link 112 may be a vertical direction with horizontal axes of the pivot joints. It is noted that the coordinate system refers to a general reference frame and is not to be limited only to correlate with characteristic directions defined by a gravitational field such as vertical and horizontal.

FIG. 4 also illustrates angles α, γ and υ which can be used to determine the coordinates (x,y) of curve 101 along which pivot joint 194 needs to be moved so that the second link remains oriented in the same direction. If, for example, b is to remain parallel to the y-axis of the coordinate system, the following equations can be used to determine the (x,y) coordinates of curve 101:

$$x = a cos ( α ) + c sin ( γ + v ) \\ y = - b + a sin ( α ) + c cos ( γ + v ) \\ cos ( γ ) = \frac{{c}^{2} - {d}^{2} + {z}^{2}}{2 cz} \\ cos ( v ) = \frac{{b}^{2} - {r}^{2} {a}^{2} + {z}^{2}}{2 bz} \\ z = \sqrt{{b}^{2} + {r}^{2} {a}^{2} - 2 abr sin ( α )} \qquad ( 1 )$$

As used in these equations, a, b, c and d denote the lengths of vectors a, b, c and d respectively or, in other words, the respective distances between the axes of the pivot joints, and r*a with 0<r<1 denotes a fraction of a. Furthermore, z denotes the distance between the axis of pivot joint 193 and the axis of pivot joint 195. The (x,y) coordinates of curve 101 in terms of α, in other words the parametric functional description x(α) and y(α) of curve 101, can be determined by eliminating z, γ and υ from the equations. It is noted that the above equations change, if b is to remain oriented along a direction other than parallel to the y-axis of the coordinate system.

In one embodiment, in general, the range of angles α for which b can remain parallel to a predetermined direction is determined by certain restrictions on combinations of the lengths r*a, b, c and d. If b is to remain parallel to the y-direction, a full range of 0<α<2π and a circular curve 101 can be established if both r*a=c and b=d. Otherwise, curve 101 is not circular and the range of angles α is restricted to certain intervals as can be readily determined from the above equations.

In one embodiment, the following inequations can determine ranges of angles α for which the system may not be able to retain a predetermined orientation of the second link. Firstly, if r*a+b≠c+d, angles α in an interval of a certain size around 3π/2 may not be accessible. Secondly, if b+c≠r*a+d, angles α in an interval of a certain size around π/2 may not be accessible.

It is noted that, depending on the accuracy required in practical applications of embodiments of the four bar linkage, a circular approximation of curve c may be employed even if the ideal curve is not circular. Practical applications generally restrict the required range of adjustable angles α and circular approximations of the ideal curve c may be practically sufficient in a number of situations. For example, when the four bar linkage is used in a trailer, for example a topdresser, in order to level the second link or an accessory attached to the second link, it may be sufficient to level the attached device to within a predetermined range of angles α. This range may extend over about a few degrees, for example. It is noted that specifically when moving the trailer over ground, it reclines as it follows the terrain and the inclination of the trailer and an attached accessory can follow accordingly. Therefore, the precision of the alignment of the second link may be relaxed in rugged applications including certain trailers such as topdressers, for example. It is noted that the present four bar linkage may also be used, for example, in fine mechanics applications that require high precision alignment.

In one embodiment of the present invention, a material handling device can comprises two four bar linkages forming the linkage system. In this configuration, the four bar linkages can be positioned on either side of a median plane of the material handling device, for example, a plane parallel along the driving axis. One of the two four bar linkages may be disposed at either side of the median plane at predetermined distances from the median plane. Each four bar linkage may be driven by its own actuator, for example a linear actuator such as a hydraulic cylinder or pneumatic cylinder or the like. If two actuators are used, they must be dependently controlled in order to achieve reasonably similar inclinations of the material holding device at either side of the of the material handling device in order to mitigate undesired torsion.

In another embodiment of the present invention, the material handling device comprises one actuator for pivotal movement of the material holding device. The actuator may be disposed centrally in or proximate a median plane of the trailer in order to move the material holding device.

Material handling device configurations employing only one actuator may simplify certain aspects of actuator control but may require stronger actuators and may affect overall mechanical design. Material handling device configurations with two actuators can provide good structural integrity, high mechanical strength and low total weight however may require a more complex system for synchronously controlling two actuators. Furthermore, a worker skilled in the art would readily understand that more than two actuators can be employed, for example three or four actuators.

### Accessory and Accessory Support

An accessory which is attached to the material handling device can be one or a variety of accessories that would be associated with particular matter transfer, for example a spreader, spinner, conveyor, auger or other mechanism as would be readily understood. In one embodiment, an accessory can have an accessory support integrated therein for coupling to the material holding device. In another embodiment an accessory support is coupled to the material holding device, wherein the accessory can be subsequently coupled to the accessory support.

According to an embodiment of the present invention, the accessory, or the accessory support, can provide the second link of the linkage system so that the benefits of the described self-levelling functionality of the linkage system can be utilized to self-level the accessory. Depending on the embodiment, the accessory may be levelled directly or indirectly via the accessory support.

In one embodiment, a modular accessory may be designed to be readily, directly or indirectly, attached or detached while an accessory support may be attached to the vehicle and linkage system in a more permanent fashion.

In another embodiment, accessories that do not provide a modular attachment function or that are not intended to be readily detachable or replaceable, may not require an accessory support. Such monolithic accessories may provide or comprise the second link and optionally even the third link of the linkage system.

In one embodiment of the present invention the accessory may comprise a conveyor or auger based particulate matter distribution system, including spreaders, for example, which may optionally be pivotable about a swivel axis perpendicular to the plane within which the accessory is levelled. The swivel axis may vary about a vertical direction depending on the overall inclination of the material handling device under operating conditions. The range of directions that the swivel axis may assume will be governed by the terrain on which the material handling device is used. It would be readily understood that a number of reasons including stability of the vehicle and safety of the operating personnel, for example, limit the range of directions that the swivel axis may assume under operating conditions.

In one embodiment of the present invention, the material handling device may include a locking mechanism (not illustrated) for interlocking the accessory support with the material holding device, such that the accessory support substantially does not self level during movement of the material holding device. Generally, when the locking mechanism is engaged so that the accessory and the material holding device are interlocked, the second and the first link of the linkage system are interlocked relative to each other so that the accessory or accessory support cannot pivot about the second pivot joint unless the locking mechanism is disengaged. In embodiments where the first and second link can be interlocked, the third link is typically configured so that its length can vary between a predetermined minimum length and a predetermined maximum length making the third link expandable, or telescopic for example. Therefore, if the locking mechanism is engaged when an attempt to pivot the material holding device is made, the third link expands and protects the system components from being damaged. In one embodiment of the present invention, the third link of the linkage system can be an extensible rod comprising a plunger, ram or slide engaging a barrel, tube, pipe, or other elongatable link as would be readily understood by a worker skilled in the art.

The invention will now be described with reference to specific examples. It will be understood that the following examples are intended to describe embodiments of the invention and are not intended to limit the invention in any way.

### EXAMPLE

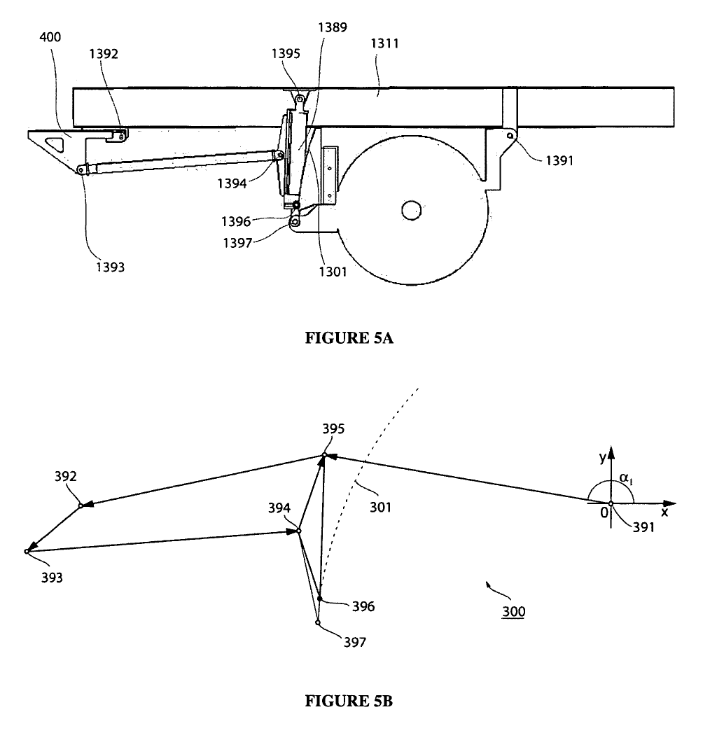

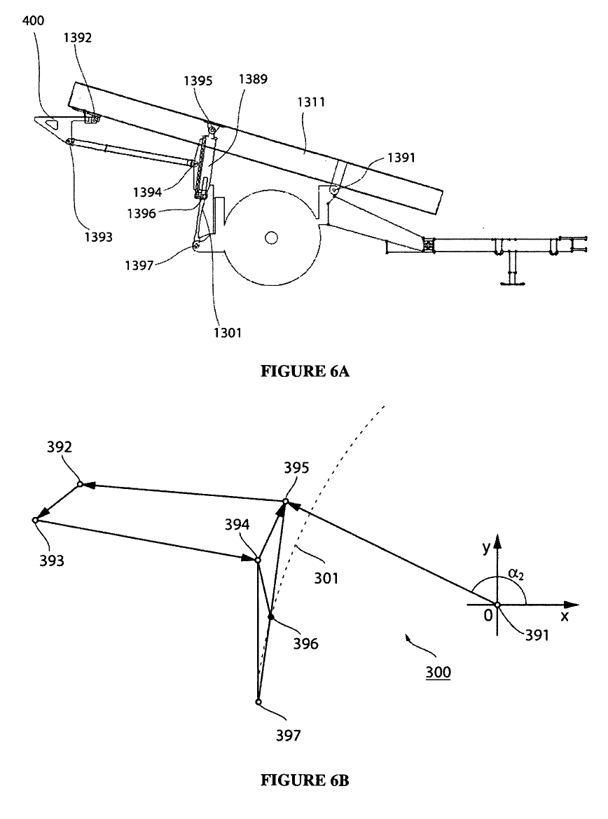

FIG. 5A illustrates a side view of a single axle material handling device according to the present invention, wherein this embodiment of the material handling device comprises a linkage system configured as a four bar linkage and wherein the material holding device is in a lowered orientation. FIG. 5B schematically illustrates the components of the linkage system of the material handling device illustrated in FIG. 5A. In addition FIG. 6A illustrates the material handling device of FIG. 5A in an elevated orientation. FIG. 6B schematically illustrates the components of the linkage system in this elevated orientation.

Having regard to FIG. 5A, the linkage system comprises a first link defined by locations 1391, 1395 and 1392, wherein this first link, while not being linear in nature is rigid as it is defined by the material holding device 1311 (illustrated in part). The second link, which is defined by the accessory support 400, is pivotable about two locations namely 1392 and 1393. As such the accessory support 400 is pivotally connected to the material holding device at location 1392. The third link interconnects the accessory support and a support bracket associated with the actuator 1389. The support bracket is configured to substantially protect the actuator from perpendicular forces by transferring forces which are directed towards the actuator towards location 1395 of the first link and the contact point 1396. The support bracket also comprises a guiding element, for example, a roller, protruding bolt, roller bearing, friction bearings or the like which abuts the arc shaped guiding element 1301 to form a contact bearing defining contact point 1396. The guiding element is coupled to the support trailer, and defines a shape which at least in part enables the self levelling of the accessory support during pivotal movement of the material holding device.

FIG. 5B illustrates the linkage defined about as a schematic representation thereof, wherein locations 1391, 1395, 1392, 1393 and 1394 illustrated in FIGS. 5A and 6A correspond to schematically to 391, 395, 392, 393 and 394 illustrated in FIGS. 5B and 6B. In addition, contact point 1396 of FIGS. 5A and 6A correspond to location 396 of FIGS. 5B and 6B and the shape defined by the guiding element 1301 is schematically illustrated as curve 301.

As with the other embodiments, the four bar linkage can be configured so that the second link which is defined by the accessory support remains parallel to a desired fixed direction for substantially all angles α within a predetermined range of angles, by moving the contact point 1396 along the curve defined by the guiding element 1301.

The support bracket defining pivot joints 1394 and 1395 as well as contact point 1396 can be configured to provide sufficient clearance for movements of the actuator. The actuator drives the four bar linkage and can be a hydraulic cylinder, pneumatic cylinder, electrical actuator or other actuator format as would be readily understood. When the actuator expands, it increases the distance between pivot joints 1395 and 1397 and consequently affects the inclination of the first link of the linkage system by reclining the material holding device. As illustrated the inclination occurs in a clockwise fashion relative to the support trailer when the actuator elongates and counter clockwise when the actuator contracts. The remaining links of the linkage system will automatically realign under the weight supported by the linkage system in correspondence with the expansion or contraction of the actuator, thereby substantially maintaining the accessory support in a desired orientation.

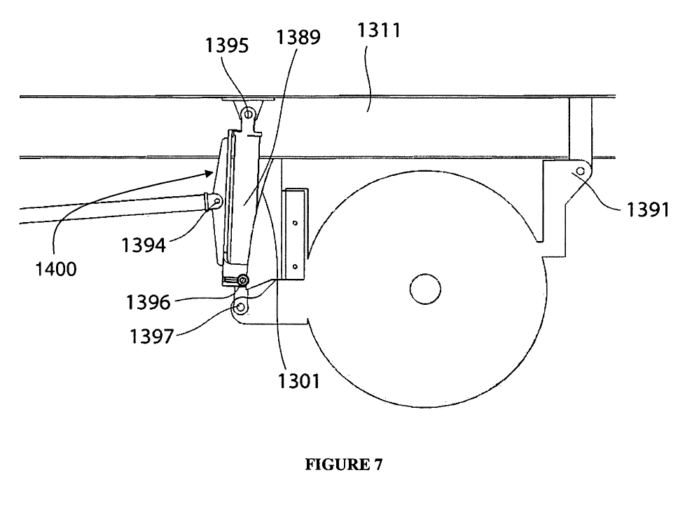

FIG. 7 illustrates a closer view of the material handling device of FIG. 5A. In particular the support bracket 1400 can be readily identified in this figure.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A material handling device comprising:
(a) a support trailer configured for movement thereof;
(b) a material holding device pivotally connected to the support trailer, the material holding device configured for reversible rotational movement between a first lowered orientation and a second elevated orientation;
(c) an accessory support pivotally connected to the material holding device, wherein the accessory support is coupled to the material holding device at a location wherein the accessory support translates when the material holding device is reversably moved between the first lowered orientation and the second elevated orientation; and
(d) a linkage system operatively interconnecting the support trailer, the material holding device and the accessory support, wherein the linkage system is configured to substantially maintain a desired orientation of the accessory support during reversible rotational movement of the material holding device.

2. The material handling device according to claim 1, wherein the desired orientation of the accessory is substantially maintained within a predetermined angle range.

3. The material handling device according to claim 1, wherein the linkage system comprises a four bar linkage.

4. The material handling device according to claim 1, wherein the linkage system comprises two four bar linkages.

5. The material handling device according to claim 4, wherein the each of the four bar linkages are disposed on either side of a longitudinal median plane of the material handling device.

6. The material handling device according to claim 1, further comprising a locking mechanism configured to interlock the accessory support with the material holding device, thereby limiting relative movement between the accessory support and the material holding device.

7. The material handling device according to claim 1, wherein the linkage system abuts a guiding element which is coupled to the support trailer, said guiding element defining a shape which at least in part substantially maintains a desired orientation of the accessory support during reversible rotational movement of the material holding device.

8. The material handling device according to claim 7, wherein the linkage system abuts the guiding element with a contact bearing.

9. The material handling device according to claim 8, wherein the guiding element has a curved shape.

10. The material handling device according to claim 8, wherein the guiding element has a partial circular shape.

11. The material handling device according to claim 1, wherein an accessory is operatively coupled to the accessory support.

12. The material handling device according to claim 11, wherein the accessory is pivotally connected to the accessory support.

13. The material handling device according to claim 11, wherein the accessory is a conveyor or an auger.

14. The material handling device according to claim 13, wherein the conveyor is configured to be pivotally movable about a substantially vertical axis.
